(19) United States
(12) Patent Application Publication
(10) Pub. No.: US 2026/0368157 A1
(43) Pub. Date: Nov. 19, 2026

(54) UPDATING A DECISION TREE TO SKIP ACCESSES OF DATA BLOCKS

(71) Applicant: International Business Machines Corporation, Armonk, NY (US)

(72) Inventors: Anand Eswaran, Bengaluru (IN); Aishwariya Chakraborty, Bankura (IN); Pankaj Thorat, Bangalore (IN); Praveen Jayachandran, Bangalore (IN)

(21) Appl. No.: 19/209,550

(22) Filed: May 15, 2025

(51) Int. Cl. G06F 16/242; G06F 16/22; G06F 16/23

(52) U.S. Cl. CPC G06F 16/2425; G06F 16/2246; G06F 16/2365

(57) ABSTRACT

A method, according to one embodiment, comprises extracting predicates from a set of previous queries, classifying the predicates based on degrees that the predicates vary from one another within the previous queries over time, and partitioning the predicates into dimensions within a data distribution, where the dimensions are based on the classifications. The method further comprises using the dimensions to update a structure of nodes of a decision tree, where the updated structure of the nodes is configured to skip accesses of data blocks associated with a first subset of the predicates that vary more than a predetermined degree within the previous queries over time. The method further comprises using the decision tree with the updated structure of the nodes to fulfill new queries.

### BACKGROUND

The present invention relates to data storage, and more specifically, this invention relates to fulfillment of queries in a data storage system.

Network environments, including data storage systems, collect, process, and/or store data at unprecedented scale. Typically collected data is stored in a lakehouse and/or data lake. Furthermore, persistence in relatively cheap disaggregated cloud storage is utilized in order to ensure that sufficient storage resources are available within an operating budget of a company that offers services within such network environments. Scan-oriented data access strategies are also used to access the collected data.

### SUMMARY

A method, according to one embodiment, comprises extracting predicates from a set of previous queries, classifying the predicates based on degrees that the predicates vary from one another within the previous queries over time, and partitioning the predicates into dimensions within a data distribution, where the dimensions are based on the classifications. The method further comprises using the dimensions to update a structure of nodes of a decision tree, where the updated structure of the nodes is configured to skip accesses of data blocks associated with a first subset of the predicates that vary more than a predetermined degree within the previous queries over time. The method further comprises using the decision tree with the updated structure of the nodes to fulfill new queries.

A computer program product, according to another embodiment, comprises one or more computer-readable storage media, and program instructions stored on the one or more storage media to perform the foregoing method.

A computer system, according to another embodiment, comprises a processor set, one or more computer-readable storage media, and program instructions stored on the one or more storage media to cause the processor set to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a diagram of a tiered data storage system, in accordance with one embodiment of the present invention.

FIG. 3 is a flowchart of a method, in accordance with one embodiment of the present invention.

FIGS. 4A-4B depict a decision tree, in accordance with several embodiments of the present invention.

FIG. 5 is a flowchart of a method, in accordance with one embodiment of the present invention.

FIGS. 6A-6B depict plots for classifying predicates of queries, in accordance with several embodiments of the present invention.

FIGS. 7A-7C depict plots for dealing with closed versus open projections along a dimension, in accordance with various embodiments of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for updating a decision tree to skip accesses of data blocks.

In one general embodiment, a method comprises extracting predicates from a set of previous queries, classifying the predicates based on degrees that the predicates vary from one another within the previous queries over time, and partitioning the predicates into dimensions within a data distribution, where the dimensions are based on the classifications. The method further comprises using the dimensions to update a structure of nodes of a decision tree, where the updated structure of the nodes is configured to skip accesses of data blocks associated with a first subset of the predicates that vary more than a predetermined degree within the previous queries over time. The method further comprises using the decision tree with the updated structure of the nodes to fulfill new queries.

In another general embodiment, a computer program product comprises one or more computer-readable storage media, and program instructions stored on the one or more storage media to perform the foregoing method.

In another general embodiment, a computer system comprises a processor set, one or more computer-readable storage media, and program instructions stored on the one or more storage media to cause the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as decision tree updating code of block 150 for updating a decision tree to skip accesses of data blocks. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

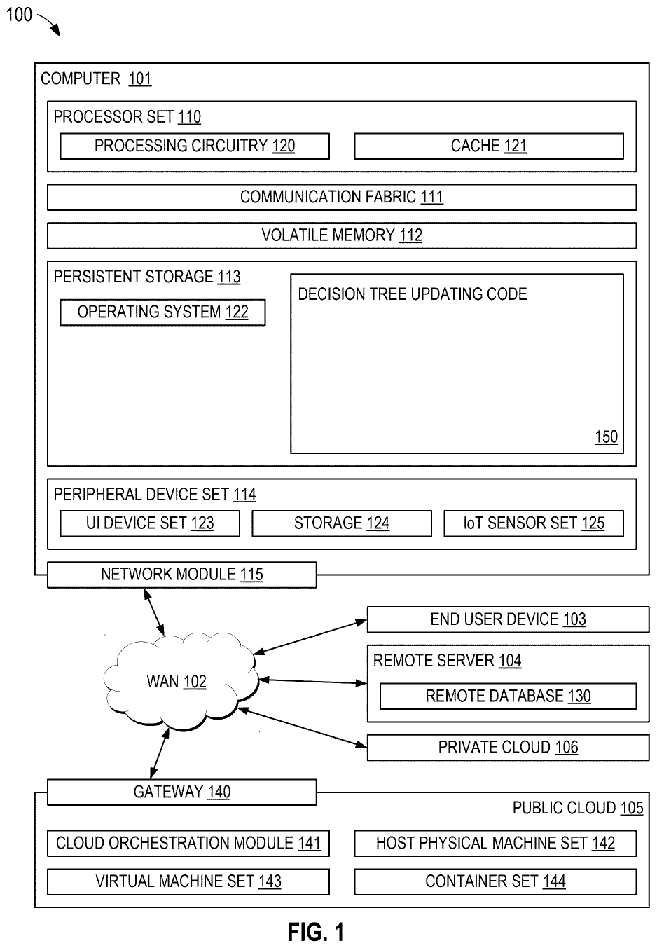

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

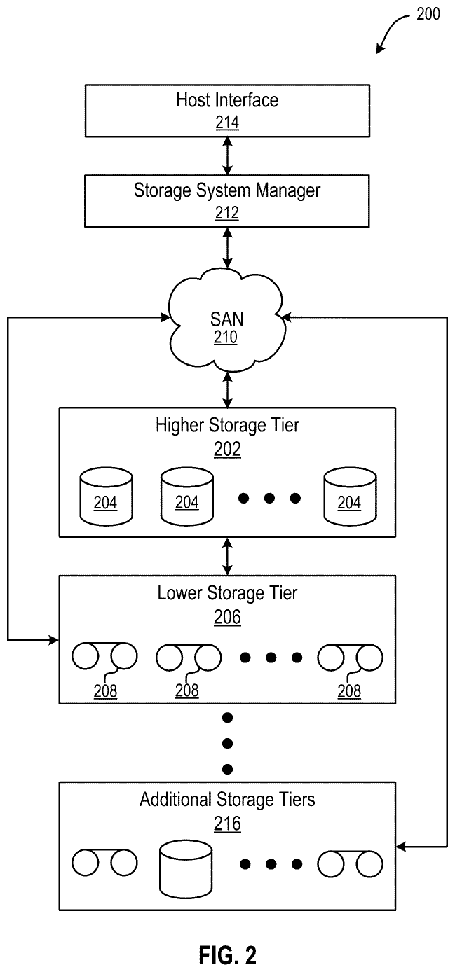

Now referring to FIG. 2, a storage system 200 is shown according to one embodiment. Note that some of the elements shown in FIG. 2 may be implemented as hardware and/or software, according to various embodiments. The storage system 200 may include a storage system manager 212 for communicating with a plurality of media and/or drives on at least one higher storage tier 202 and at least one lower storage tier 206. The higher storage tier(s) 202 preferably may include one or more random access and/or direct access media 204, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 200. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a SAN, as shown in FIG. 2, Internet Protocol (IP) network, or some other suitable network type. The storage system manager 212 may also communicate with one or more host systems (not shown) through a host interface 214, which may or may not be a part of the storage system manager 212. The storage system manager 212 and/or any other component of the storage system 200 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 200 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the embodiments presented herein.

According to some embodiments, the storage system (such as 200) may include logic configured to receive a request to open a data set, logic configured to determine if the requested data set is stored to a lower storage tier 206 of a tiered data storage system 200 in multiple associated portions, logic configured to move each associated portion of the requested data set to a higher storage tier 202 of the tiered data storage system 200, and logic configured to assemble the requested data set on the higher storage tier 202 of the tiered data storage system 200 from the associated portions.

As mentioned elsewhere herein, network environments, including data storage systems, collect, process, and/or store data at unprecedented scale. Typically collected data is stored in a lakehouse and/or data lake. Furthermore, persistence in relatively cheap disaggregated cloud storage is utilized in order to ensure that sufficient storage resources are available within an operating budget of a company that offers services within such network environments. Scan-oriented data access strategies are also used to access the collected data.

As the amount of data that is collected, processed, and/or stored increases, the amount of processing resources and time that is required to accurately fulfill queries also increases. This is because the number of blocks of data that are searched and analyzed to determine relevant data for such queries often increases as a greater rate than processing resources are added to the network environment. It should further be noted that simple solutions such as sort-orders have not worked to remedy these deficiencies. Accordingly, there is a longstanding and unmet need for techniques that streamline query fulfillment by reducing the extent of data blocks that are analyzed to fulfill queries.

In order to mitigate the deficiencies described above and thereby decrease the time and processing resources expended in fulfilling queries in a network environment, embodiments and approaches described herein enable the skipping of entire data blocks that are irrelevant to a query at hand. More specifically, in order to enable this skipping, these techniques leverage semantics of workload queries and data distribution of a data set to skip entire blocks intelligently in a cloud setting. In order to enable this outcome, a semantic block skipping tree and/or index is built and/or ongoingly updated for eliminating unnecessary data accesses. This way, these techniques reduce read costs and increase I/O performance in data storage systems.

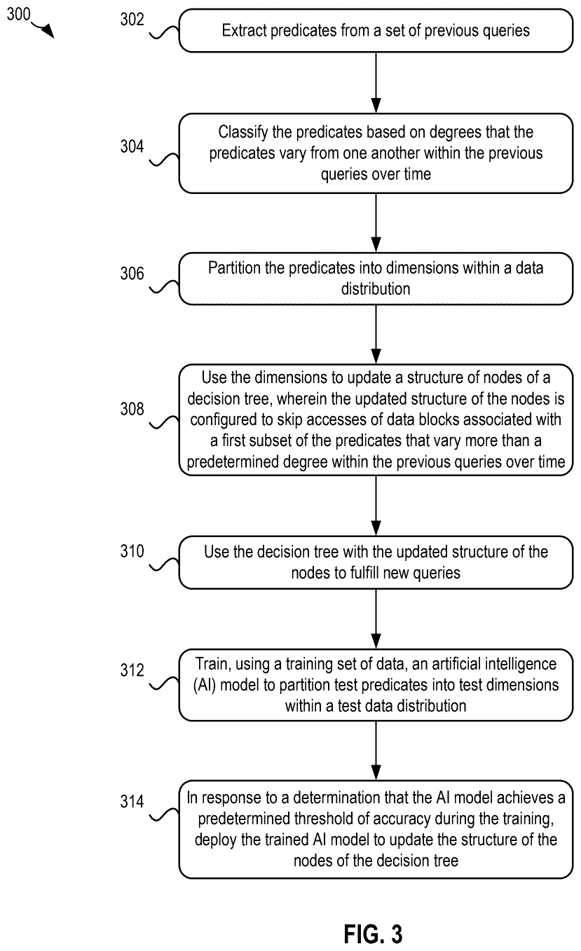

Now referring to FIG. 3, a flowchart of a method 300 is shown according to one embodiment. The method 300 may be performed in accordance with aspects of the present invention in any of the environments depicted in FIGS. 1-7C, among others, in various embodiments. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that the operations and/or techniques of method 300 may be performed in a network environment that includes a data storage system. The data storage system, in some approaches, includes one or more data storage resources for storing data, e.g., see FIGS. 1-2. Furthermore, in some preferred approaches, the data storage system includes resources for receiving and/or fulfilling queries for data blocks. These resources, in some approaches, include a data engine scan operator of a type that would become apparent to one of ordinary skill in the art after reading the descriptions herein. These resources may additionally and/or alternatively include processing resources that are used by an artificial intelligence (AI) model, which is described in further detail elsewhere herein.

Operation 302 includes extracting predicates from a set of previous queries. These queries may, in some approaches, be tracked across successive epochs of time during operation of the data storage system. Predicate extraction techniques may be of a type that would become apparent to one of ordinary skill in the art after reading the descriptions herein. In some approaches, these techniques include causing, e.g., instructing, a large language model (LLM) to analyze the queries, and based on the analysis, extract predetermined words and/or strings according to one or more predetermined rules.

With the predicates of the set of previous queries extracted, a classification protocol may be followed in order to identify similarities and differences between the different predicates over time. For example, operation 304 includes classifying the predicates based on degrees that the predicates vary from one another within the previous queries over time. For context, the classification of the predicates is performed to determine (and based on) degrees of variance that the parameters have over epochs of successive time.

More specifically, in order to perform such classification, method 300, in some approaches, includes tracking the workloads (sets of queries) across “epochs” of time within a predetermined range of time (a time period). For these epochs of time, all predicates may be extracted from successive epochs under sets “P_{old}” and “P_{new}” and a comparative analyze may be performed to determine what has changed. The projections of a query along each dimension, of predetermined dimensions, are used to classify each predicate “p” in “P_{new}”. In some approaches, the classifying the predicates based on the degrees that the predicates vary from one another within the previous queries over time comprises classifying, based on attributes of the predicates, the predicates as being open predicates or closed predicates. In one or more of such approaches, in response to a determination that the starting offset and the width of the projection (approximately within a predetermined degree) overlaps with some entry “p” in “P_{old}”, the predicate associated with the entry p is labelled as closed, e.g., the exact value of this predicate in this query is determined to repeat over epochs. In contrast, in response to a determination that width and/or offsets are dissimilar (not within a predetermined degree of similarity) from predicates in prior epochs, the predicate may be called an open predicate. In other words, the first subset of the predicates may be classified as being open predicates based on attributes of the first subset of the predicates varying more than the predetermined degree within the previous queries over time, while a second subset of the predicates may be classified as being closed predicates based on attributes of the second subset of the predicates not varying more than the predetermined degree within the previous queries over time.

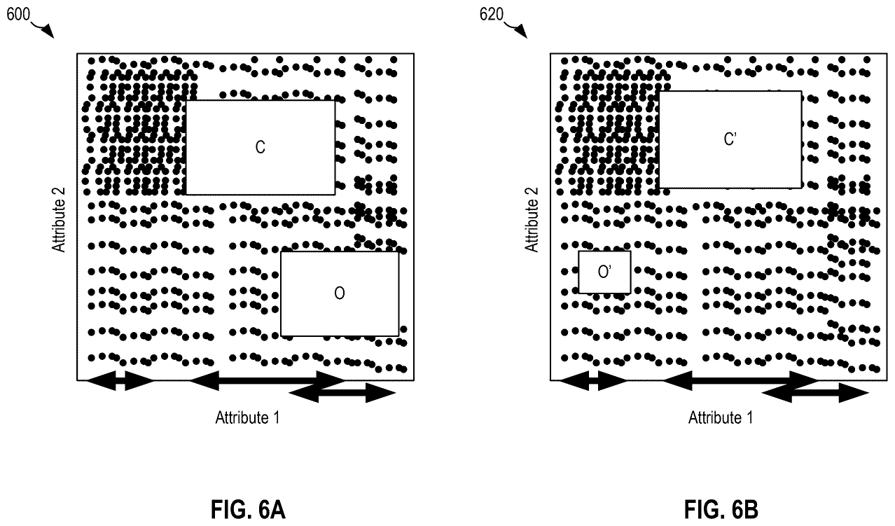

Operation 306 includes partitioning the predicates into dimensions within a data distribution that characterizes attributes of the predicates over the time, where the dimensions are based on the classifications. This partitioning operation, in some approaches, deals with closed versus open projections along a dimension. Points are dispersed within the dimension, and may be plotted with respect to different axes, e.g., see attribute 1 versus attribute 2 in FIGS. 6A-6B. These attributes may be predicate attributes of a type that would become apparent to one of ordinary skill in the art after reading the descriptions herein. Per dimension, a cut is picked and/or made to establish the partitions such that the skipping requirements of closed and open predicates in the new epoch are satisfied.

In some approaches, with respect to open predicates, operation 306 includes taking the Cumulative Distribution Function (CDF) of the data distribution along that dimension. Meanwhile, in some approaches, for closed predicates (or groups of overlapping closed predicates), the dimension may be covered by a single partition and any remaining density mass within the data distribution (remaining points) may be reapportioned across any remaining partitions. When performing the partitioning, in some approaches, the process may initiate with two partitions, and in every subsequent iteration the process may be performed with twice the number of previous partitions until a determination that diminishing returns are detected, i.e., |P(2D)−P(D)/P(D)|<f(0<=f<=1), where the variable P(D) represents the given partition for a function f.

The dimensions are used to update a structure of nodes of a decision tree, e.g., see operation 308. The updated structure of the nodes is preferably configured to skip accesses of data blocks associated with a first subset of the predicates that vary more than a predetermined degree within the previous queries over time. In other words, in some approaches, these updates cause a maximum number of data blocks associated with the open predicates to be skipped during use of the decision tree to fulfill new queries. Detailed techniques for initially building the decision tree and techniques for then updating the decision tree are detailed below, in some approaches.

In some approaches, the decision tree is built using a heuristic approach. In such an approach, in every iteration, a dimension is picked as the cut and the predicates created in last step are used as cuts of the decision tree, e.g., thereby establishing logical paths of nodes extending from a root node to leaf nodes of the decision tree. In some approaches, the dimension (column) is picked using a relatively greedy cost function. For example, in one concept, a column “c” is picked which is determined to maximize blocks skipped during use of the decision tree thereafter to fulfill new queries. In such an example, a function: f(c, Q) may be defined as a sum over all partitions of c(|Sc(p)|*sum over all queries q in Q ([q, Sc(p)])), where S(p) is a size of partition p of column c. In some approaches, [q, Sc(p)] is Iverson's bracket which is 1 if Sc(p) can be skipped for q and is 0 otherwise. This way, the dimension c which maximizes f(c,Q) may be used when generating the decision tree. This step may be recursively repeated over a remaining dimension for each child node until a determination is made that no dimensions remain or a block size of a current node is determined to be “sufficiently small” (less than a predetermined threshold value). In some other approaches, alternative approaches may use an AI model and/or deep reinforcement learning to learn good cuts. Note that techniques for training such a model for deployment are described elsewhere herein.

In some approaches, techniques for updating the decision tree may include ongoingly recalculating the decision tree, e.g., every epoch. This way, rather than building the decision tree once upfront, the tree is continuously optimized based on the stability of columns to stabilize the tree and result in the best long-term data skipping tree. The transition from T_{old}-epoch to T_{new}-epoch may be a tree-edit distance problem. To address this, some approaches may use techniques such as Zhang-Sasha algorithm which is a dynamic programming based tree-edit algorithm that performs string edit distances to solve the problem. However, in some approaches, an even more efficient solution includes taking a relatively more practical approach of trying to first stabilize the structure of the decision tree, as described in various approaches, below.

In some approaches, in order to stabilize the decision tree, down-weighing may be performed on columns that are determined to change positions relatively significantly over successive epochs. For example, for this stabilization technique, the using the dimensions to update the structure of nodes of the decision tree comprises prioritizing the dimensions within the data distribution having relatively more closed predicates relatively closer to and/or at a root of the decision tree. For context, by placing these dimensions relatively closer to the root of the decision tree, data blocks associated with these dimensions is relatively more likely to be read rather than be skipped during fulfillment of a subsequent query. Furthermore, this update promotes relatively less intensive update operations being performed on the decision tree as these dimensions are determined to historically have remained relatively more stable than other dimensions. With continued reference to the stabilization technique, the using the dimensions to update the structure of nodes of the decision tree may additionally and/or alternatively comprise prioritizing the dimensions within the data distribution having relatively more open predicates relatively closer to and/or at leave(s) of the decision tree.

In some approaches, for the stabilization technique described above, a new cost function f′(c,Q)=f(c,Q)/1+|tree-height(c) new_epoch−tree-heightprev-epoch|may be created to down-weigh columns that are determined to not be stable across epochs. Tree-height (T,c)new_epoch/old_epoch is the average height of all nodes of column type c from the root in Tnew-epoch to Told-epoch. This ensures that the cut contribution of stable columns are weighed relatively higher than those of unstable columns.

In some approaches, in order to stabilize the decision tree, method 300 may additionally and/or alternatively include snipping and/or adding to contents of the decision tree. For example, the using the dimensions to update the structure of nodes of the decision tree, in some approaches, comprises at least temporarily removing the nodes associated with the data blocks associated with the first subset of the predicates. Furthermore, the using the dimensions to update the structure of nodes of the decision tree may additionally and/or alternatively comprise reorganizing a first portion of the nodes of the decision tree, where the reorganizing comprises estimating and comparing costs of a plurality of potential reorganization plans. The costs are, in some approaches, based on one or more factors selected from a group of factors. In one approach, the factors include an amount of processing resources used to perform the reorganization plans. In another approach, the factors additionally and/or alternatively include a financial cost of performing the reorganization plans. In yet another approach, the factors additionally and/or alternatively include an amount of processing resources expected to be saved by using the updated structure of the nodes to fulfill the new queries (based on the skipped accesses of data blocks associated with a first subset of the predicates that vary more than a predetermined degree within the previous queries over time). In another approach, the factors additionally and/or alternatively include a financial cost expected to be saved by using the updated structure of the nodes to fulfill the new queries. Forecasting and/or estimation models of a type that would become apparent to one of ordinary skill in the art after reading the descriptions herein may be used to determine values of such factors.

Given the considerable cost of changing data layouts dynamically, the techniques described herein that weigh in favor of stability and robustness is important to ensure a practical solution while preserving processing resources during fulfillment of queries. Over time, with this approach, the decision tree converges to a structure with ongoingly increasing efficiency. It should be noted that, in some approaches, epoch sizes typically range from few weeks to few months, although these epoch sizes may differ in other approaches.

Operation 310 includes using the decision tree with the updated structure of the nodes to fulfill new queries. In some preferred approaches, the using the decision tree with the updated structure of the nodes to fulfill the new queries comprises in response to receiving the new queries from a first user device, causing, e.g., instructing, a data engine scan operator to use the decision tree with the updated structure of the nodes to fulfill the new queries. It should be noted that, unlike typical scan operators that have hard-coded logic, here the scan operator implementation preferably changes as the data layout changes. Accordingly, the layout changes are, in some approaches, automatically synchronized with scan operator changes. This operation must be localized to scan operator and should be oblivious to stages downstream of the scan).

For integrating the decision tree with the data engine scan operator, the data engine scan operator uses the decision tree for both accessing blocks and for classifying rows into blocks. Given that blocks are coarse grained data containers (at the granularity of many thousands of rows), the overheads of passing a query through the decision tree are considered well worth the costs given the savings gained from skipping data in those blocks. Each block is, in some approaches, stored in a separate Parquet file with its own metadata (e.g. stored in Iceberg metadata), so the approach fits well with the lakehouse approach.

The data engine scan operator uses the decision tree with the updated structure of the nodes for skipping accesses of data blocks associated with the first subset of the predicates, accessing data blocks associated with the second subset of the predicates, and classifying rows of the data distribution into data blocks. An output of the data engine scan operator may include answers to the new queries. Accordingly, in some approaches, the using the decision tree with the updated structure of the nodes to fulfill the new queries comprises formulating an answer to the new queries based on an output of the data engine scan operator and outputting the answer to the first user device. Note that the output of the data engine scan operator includes the data of the accessed blocks but does not include data from blocks that were skipped. These skips are, in some approaches, performed during scans performed by the data engine scan operator in tabular disengaged stores of data.

In some approaches, the operations of method 300 may be performed by an AI model that is trained using a predetermined training set of data. For example, in some approaches, various of the operations noted above may be deployed in a trained state of a trained AI model. Training of the AI model, in some approaches, may be performed by applying a predetermined training data set. For example, in some approaches, method 300 includes training, using a training set of data, an artificial intelligence (AI) model to partition test predicates into test dimensions within a test data distribution, where the test dimensions are based on test classifications within the training set of data, e.g., see operation 312. Initial training may include reward feedback that may, in some approaches, be implemented using a subject matter expert (SME) that generally understands whether the AI model is accurate in an initial relatively small batch of estimations. However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 300 may be performed. For example, in response to a determination that the AI model achieves a predetermined threshold of accuracy during the training, the trained AI model is deployed to update the structure of the nodes of the decision tree, e.g., see operation 314.

In some further approaches, the AI model may be a neuromyotonic AI model that may improve performance of computer devices in an infrastructure associated with a data storage system, because the neuromyotonic AI model may not need an SME and/or iteratively applied training with reward feedback in order to accurately perform operations described herein. Instead, the neuromyotonic AI model is configured to itself make determinations described in operations herein. Weight values may, in some approaches, be used by the AI reasoning model to collect and analyze information and/or feedback potentially received from user devices that issue queries. Such an AI model ensures that inaccurate data blocks (those that do not relatively accurately correspond to a query) are skipped as a result of use of the decision tree, where the scale of such analysis and determinations would not otherwise be feasible for a human to perform. This is because humans are not able to efficiently manage query fulfillment of the scale described herein, and would otherwise incorporate processing delays and errors in the structuring of the decision tree in the process of attempting to do so. Accordingly, management of operations described herein is not able to be achieved by human manual actions.

The techniques of embodiments and approaches described herein reduce the cost of fulfilling queries by eliminating expensive lookups directly from metadata and skipping at least some data that would otherwise be read in the decision tree without performance of operations described herein. This translates to a relatively improved performance within the data storage system by enabling a relatively higher I/O bandwidth by avoiding unnecessary data processing costs. These techniques furthermore enable a deep context-awareness during query fulfillment as the decision tree is customized to the workload at hand, e.g., the set of queries that are received. Accordingly, a data distribution of data set can be customized to the cloud at hand (use cloud-specific storage and/or cache API). These techniques are furthermore dynamic and adaptive to changing conditions as they enable an ability to change characteristics as data distributions and workloads change. In some approaches, all changes and/or complexities are hidden from rest of the analytical processing system of the network environment.

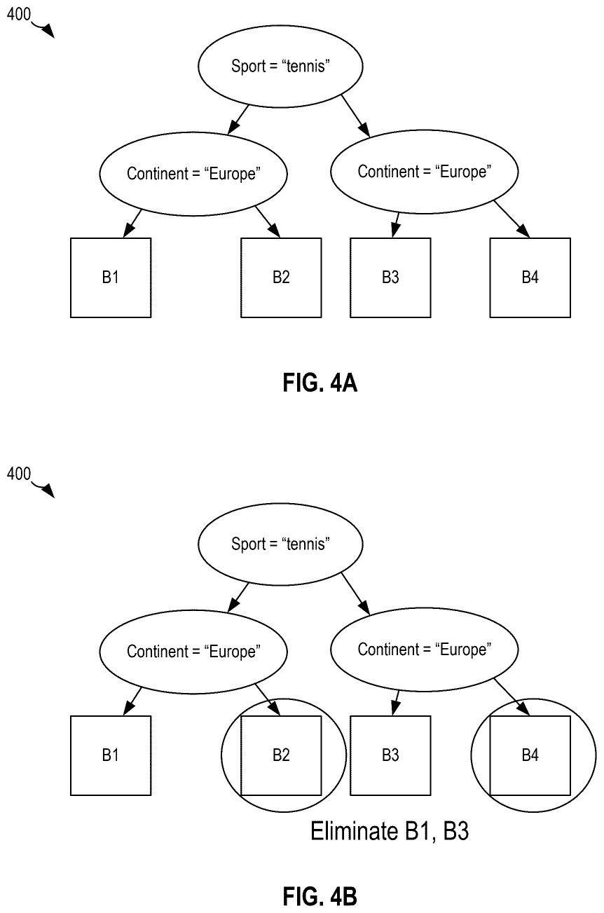

FIGS. 4A-4B depict a decision tree 400, in accordance with several embodiments. As an option, the present decision tree 400 may be implemented in conjunction with features from any other embodiment listed herein, such as those described with reference to the other FIGS. Of course, however, such decision tree 400 and others presented herein may be used in various applications and/or in permutations which may or may not be specifically described in the illustrative embodiments listed herein. Further, the decision tree 400 presented herein may be used in any desired environment.

Within FIG. 4A, the decision tree 400 is shown with a root node, e.g., see Sport=“tennis”, among other nodes, e.g., see Continent=“Europe”. The decision tree 400 also includes leaf nodes, e.g., see B1-B4. The techniques described herein, e.g., see method 300, may be used to update the structure of the nodes of the decision tree. Referring now to FIG. 4B, based on an analysis of previous queries, the structure of the nodes may be configured to skip accesses of data blocks associated with a first subset of the predicates that vary more than a predetermined degree within the previous queries over time, e.g., see leaf nodes B1 and B3 being eliminated from the decision tree as a part of the update.

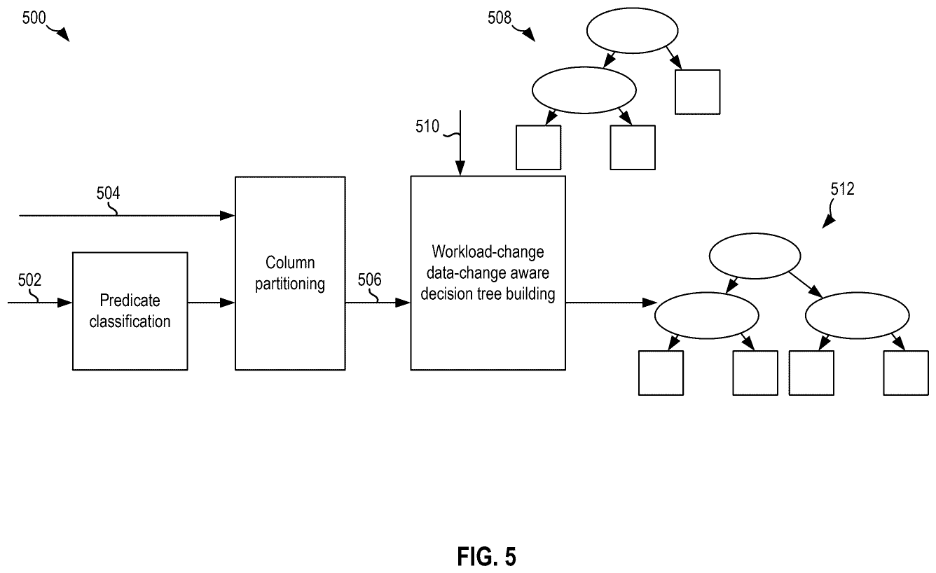

Now referring to FIG. 5, a flowchart of a method 500 is shown according to one embodiment. The method 500 may be performed in accordance with aspects of the present invention in any of the environments depicted in FIGS. 1-7C, among others, in various embodiments. Of course, more or fewer operations than those specifically described in FIG. 5 may be included in method 500, as would be understood by one of skill in the art upon reading the present descriptions.

Each of the steps of the method 500 may be performed by any suitable component of the operating environment. For example, in various embodiments, the method 500 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 500. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 500 represents a logical overview of operations similar to those described in greater detail elsewhere herein in method 300. In operation 502, a plurality of past and/or current queries are received and/or obtained based on monitoring performed over sequential epochs. Predicates are extracted and classified, e.g., see Predicate classification in which the predicates are classified as closed and open predicates. Data Distributions of Columns (CDF) are incorporated into column partitioning performed using the techniques described herein, e.g., see operation 504 and Column portioning. Here, for each column a determination is made as to how to best partition the column factoring in the closed and open predicates.

A workload-change data-change aware decision tree building process is performed in operation 506. This process, in some approaches, includes modifying a current decision tree 508, e.g., see operation 510. The decision tree may be built and/or updated by ordering columns (dimensions) based on maximum skipping. In some approaches, the current tree structure and the modification cost are factored into the tree building process. An output of this process includes the updated decision tree, e.g., see updated decision tree 512.

FIGS. 6A-6B depict plots 600 and 620 for classifying predicates of queries, in accordance with several embodiments. As an option, the present plots 600 and 620 may be implemented in conjunction with features from any other embodiment listed herein, such as those described with reference to the other FIGS. Of course, however, such plots 600 and 620 and others presented herein may be used in various applications and/or in permutations which may or may not be specifically described in the illustrative embodiments listed herein. Further, the plots 600 and 620 presented herein may be used in any desired environment.

The plots 600 and 620 illustrate tracked workloads (sets of queries) across “epochs” of time. All predicates are extracted from these queries and characterized with respect to different attributes, e.g., see Attribute 1 versus Attribute 2. All predicates are extracted from successive epochs under sets Pold (illustrated by points in FIG. 6A) and P_{new} (illustrated by points in FIG. 6B) and an analysis is performed to determine what has changed, e.g., see C to C′ and O to O′. The projections of a query along each dimension are used to classify each predicate p in P_{new}. In response to a determination that the starting offset and the width of the projection (approx.) overlaps with some entry p′ in P_{old}, p is labelled as closed i.e. the exact value of this predicate in this query repeats over epochs. Meanwhile, in response to a determination that width or offsets are dissimilar from predicates in prior epochs, the predicate is classified as an open predicate.

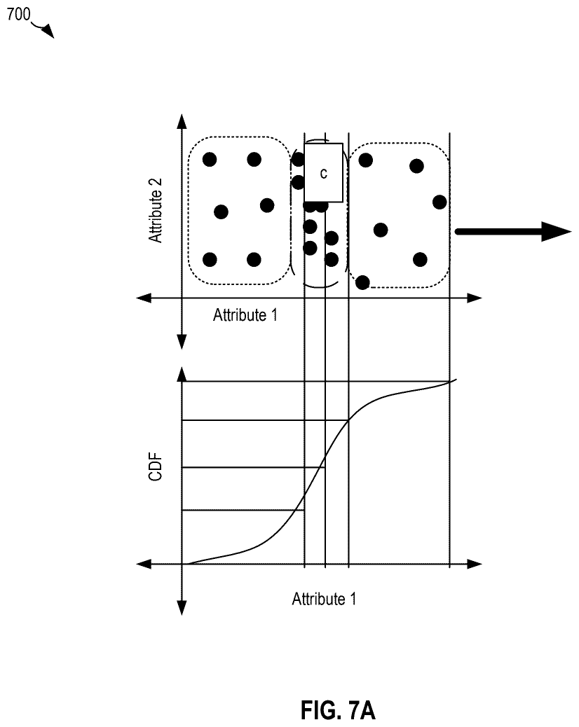

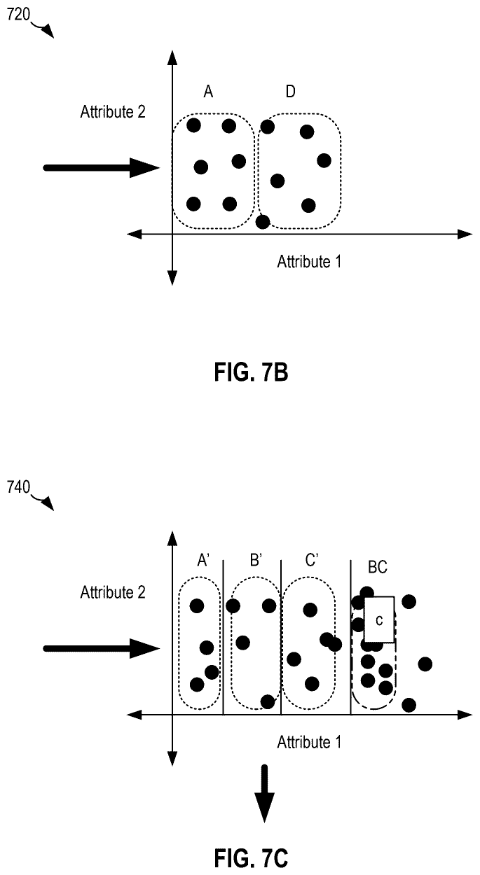

FIGS. 7A-7C depict plots 700, 720 and 740 for dealing with closed versus open projections along a dimension, in accordance with various embodiments. As an option, the present plots 700, 720 and 740 may be implemented in conjunction with features from any other embodiment listed herein, such as those described with reference to the other FIGS. Of course, however, such plots 700, 720 and 740 and others presented herein may be used in various applications and/or in permutations which may or may not be specifically described in the illustrative embodiments listed herein. Further, the plots 700, 720 and 740 presented herein may be used in any desired environment.

Referring first to FIG. 7A, plot 700 illustrates attributes of predicates plotted with respect to different attributes. Per dimension, a cut is picked such that the skipping requirements of closed and open predicates in a new epoch are satisfied. For open predicates the CDF of the data distribution is taken along that dimension, e.g., see CDF. For closed predicates (or groups of overlapping closed predicates as shown in BC of plot 700) these may be covered by a single partition and remaining density mass be reapportioned across remaining partitions, e.g., B and C can be fused so that three partitions remain and can be used to update a decision tree.

Referring now to FIG. 7B, plot 720 illustrates two cuts that include only points associated with the open predicates.

Referring now to FIG. 7C, plot 740 illustrates the nodes being equally divided into four portions. Here each range (dotted rectangle) is converted into a predicate. When comparing FIGS. 7B and 7C, an initial iteration may begin with two partitions (see plot 720), and every subsequent iteration twice the number of partitions (see four partitions in plot 740) may be used until a determination is made that diminishing returns have been met.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
extracting predicates from a set of previous queries;
classifying the predicates based on degrees that the predicates vary from one another within the previous queries over time, wherein the classifying comprises classifying, based on attributes of the predicates, the predicates as being open predicates or closed predicates, wherein a first subset of the predicates are classified as being open predicates based on attributes of the first subset of the predicates varying more than a predetermined degree within the previous queries over time, and wherein a second subset of the predicates are classified as being closed predicates based on attributes of the second subset of the predicates not varying more than the predetermined degree within the previous queries over time;
partitioning the predicates into dimensions within a data distribution, wherein the dimensions are based on the classifying,
using the dimensions to update a structure of nodes of a decision tree, wherein the updated structure of the nodes is configured to skip accesses of data blocks associated with a first subset of the predicates that vary more than a predetermined degree within the previous queries over time, wherein the using the decision tree with the updated structure of the nodes to fulfill new queries comprises:
in response to receiving the new queries from a first user device, causing a data engine scan operator to use the decision tree with the updated structure of the nodes to fulfill the new queries, wherein the data engine scan operator uses the decision tree with the updated structure of the nodes for skipping accesses of data blocks associated with the first subset of the predicates, accessing data blocks associated with the second subset of the predicates, and classifying rows of the data distribution into data blocks,
formulating an answer to the new queries based on an output of the data engine scan operator, and
outputting the answer to the first user device; and
using the decision tree with the updated structure of the nodes to fulfill the new queries.

2. (canceled)

3. The method of claim 1, wherein the using the dimensions to update the structure of nodes of the decision tree comprises: prioritizing the dimensions within the data distribution having relatively more closed predicates relatively closer to and/or at a root of the decision tree.

4. The method of claim 3, wherein the using the dimensions to update the structure of nodes of the decision tree comprises: prioritizing the dimensions within the data distribution having relatively more open predicates relatively closer to and/or at leave(s) of the decision tree.

5. (canceled)

6. The method of claim 1, wherein the using the dimensions to update the structure of nodes of the decision tree comprises: removing the nodes associated with the data blocks associated with the first subset of the predicates.

7. The method of claim 1, wherein the using the dimensions to update the structure of nodes of the decision tree comprises: reorganizing a first portion of the nodes of the decision tree, wherein the reorganizing comprises estimating and comparing costs of a plurality of potential reorganization plans.

8. The method of claim 7, wherein the costs are based on a factor selected from the group consisting of: an amount of processing resources used to perform the reorganization plans, a financial cost of performing the reorganization plans, an amount of processing resources expected to be saved by using the updated structure of the nodes to fulfill the new queries, and a financial cost expected to be saved by using the updated structure of the nodes to fulfill the new queries.

9. The method of claim 1, further comprising:
training, using a training set of data, an artificial intelligence (AI) model to partition test predicates into test dimensions within a test data distribution; and
in response to a determination that the AI model achieves a predetermined threshold of accuracy during the training, deploying the trained AI model to update the structure of the nodes of the decision tree.

10. A computer program product comprising:
one or more computer-readable storage media; and
program instructions stored on the one or more storage media to perform operations comprising:
extracting predicates from a set of previous queries;
classifying the predicates based on degrees that the predicates vary from one another within the previous queries over time, wherein the classifying comprises classifying, based on attributes of the predicates, the predicates as being open predicates or closed predicates, wherein a first subset of the predicates are classified as being open predicates based on attributes of the first subset of the predicates varying more than a predetermined degree within the previous queries over time, and wherein a second subset of the predicates are classified as being closed predicates based on attributes of the second subset of the predicates not varying more than the predetermined degree within the previous queries over time;
partitioning the predicates into dimensions within a data distribution, wherein the dimensions are based on the classifying,
using the dimensions to update a structure of nodes of a decision tree, wherein the updated structure of the nodes is configured to skip accesses of data blocks associated with a first subset of the predicates that vary more than a predetermined degree within the previous queries over time, wherein the using the decision tree with the updated structure of the nodes to fulfill new queries comprises:
in response to receiving the new queries from a first user device, causing a data engine scan operator to use the decision tree with the updated structure of the nodes to fulfill the new queries, wherein the data engine scan operator uses the decision tree with the updated structure of the nodes for skipping accesses of data blocks associated with the first subset of the predicates, accessing data blocks associated with the second subset of the predicates, and classifying rows of the data distribution into data blocks,
formulating an answer to the new queries based on an output of the data engine scan operator, and
outputting the answer to the first user device; and
using the decision tree with the updated structure of the nodes to fulfill the new queries.

11. (canceled)

12. The computer program product of claim 10, wherein the using the dimensions to update the structure of nodes of the decision tree comprises: prioritizing the dimensions within the data distribution having relatively more closed predicates relatively closer to and/or at a root of the decision tree.

13. The computer program product of claim 12, wherein the using the dimensions to update the structure of nodes of the decision tree comprises: prioritizing the dimensions within the data distribution having relatively more open predicates relatively closer to and/or at leave(s) of the decision tree.

14. (canceled)

15. The computer program product of claim 10, wherein the using the dimensions to update the structure of nodes of the decision tree comprises: removing the nodes associated with the data blocks associated with the first subset of the predicates.

16. The computer program product of claim 10, wherein the using the dimensions to update the structure of nodes of the decision tree comprises: reorganizing a first portion of the nodes of the decision tree, wherein the reorganizing comprises estimating and comparing costs of a plurality of potential reorganization plans.

17. The computer program product of claim 16, wherein the costs are based on a factor selected from the group consisting of: an amount of processing resources used to perform the reorganization plans, a financial cost of performing the reorganization plans, an amount of processing resources expected to be saved by using the updated structure of the nodes to fulfill the new queries, and a financial cost expected to be saved by using the updated structure of the nodes to fulfill the new queries.

18. The computer program product of claim 10, wherein the operations further comprise:
training, using a training set of data, an artificial intelligence (AI) model to partition test predicates into test dimensions within a test data distribution; and
in response to a determination that the AI model achieves a predetermined threshold of accuracy during the training, deploying the trained AI model to update the structure of the nodes of the decision tree.

19. A computer system comprising:
a processor set;
one or more computer-readable storage media; and
program instructions stored on the one or more storage media to cause the processor set to perform operations comprising:
extracting predicates from a set of previous queries;
classifying the predicates based on degrees that the predicates vary from one another within the previous queries over time, wherein the classifying comprises classifying, based on attributes of the predicates, the predicates as being open predicates or closed predicates, wherein a first subset of the predicates are classified as being open predicates based on attributes of the first subset of the predicates varying more than a predetermined degree within the previous queries over time, and wherein a second subset of the predicates are classified as being closed predicates based on attributes of the second subset of the predicates not varying more than the predetermined degree within the previous queries over time;
partitioning the predicates into dimensions within a data distribution, wherein the dimensions are based on the classifying,
using the dimensions to update a structure of nodes of a decision tree, wherein the updated structure of the nodes is configured to skip accesses of data blocks associated with a first subset of the predicates that vary more than a predetermined degree within the previous queries over time, wherein the using the decision tree with the updated structure of the nodes to fulfill new queries comprises:
in response to receiving the new queries from a first user device, causing a data engine scan operator to use the decision tree with the updated structure of the nodes to fulfill the new queries, wherein the data engine scan operator uses the decision tree with the updated structure of the nodes for skipping accesses of data blocks associated with the first subset of the predicates, accessing data blocks associated with the second subset of the predicates, and classifying rows of the data distribution into data blocks,
formulating an answer to the new queries based on an output of the data engine scan operator, and
outputting the answer to the first user device; and
using the decision tree with the updated structure of the nodes to fulfill the new queries.

20. (canceled)
